(19) United States
(12) Patent Application Publication
(10) Pub. No.: US 2012/0306156 A1
(43) Pub. Date: Dec. 6, 2012

(54) COMPRESSOR SEAL

(75) Inventors: Clifton R. Fockler, Riverdale, MI (US); Jeffery L. Watson, Ithaca, MI (US)

(73) Assignee: ALMA PRODUCTS COMPANY, Alma, MI (US)

(21) Appl. No.: 13/150,367

(22) Filed: Jun. 1, 2011

(51) Int. Cl. F04D 29/10; F16J 15/32

(52) U.S. Cl. 277/402

(57) ABSTRACT

The present invention is an apparatus for sealing in a compressor having a compressor housing and a rotatable shaft extending through the compressor housing, with a pressure seal having a first sealing member and a first sealing lip abutting and adjacent to, respectively, said housing and rotatable shaft, and a seal guide attached to the compressor housing and extending radially inward toward the rotatable shaft for maintaining alignment of the pressure seal.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE

Not Applicable.

### BACKGROUND OF THE INVENTION

1. Field of the Invention

The present invention pertains to compressor sealing devices. The invention more particularly concerns a sealing device comprising a pressure seal and seal guide disposed in the annular space or cavity between a compressor's housing and rotatable shaft.

2. Discussion of the Background

Open compressors, such as those employed in automobile air conditioning systems, require the use of sealing mechanisms to prevent oil and coolant fluids from leaking from high-pressure compartments into lower-pressure compartments. A compressor of this type generally includes a rotating shaft which penetrates a housing structure. The sealing mechanism is disposed in the limited annular space between the shaft and the housing, and is subjected to frictional forces in areas where certain dynamic sealing surfaces slide or rub against each other as the shaft rotates—which may result in wear-and-tear to the mechanism.

Any number of sealing mechanisms are known in the art which comprise, generally, one or more rubber sealing lips which abut a compressor's rotatable shaft along its periphery, one or more sealing members which may comprise sealing lips, rings or similar structures which abut and are generally attached to the inner surface of the housing, and intermediate structures made of metal or similar rigid or semi-rigid materials to which the sealing lips and sealing members are fixed. The intermediate structures, which may include brackets, washers, or cases provide support for the sealing lips and prevent deformation of the sealing mechanism.

An example of the aforementioned sealing mechanism type is found in U.S. Patent Application Pub. 2001/0030398 A1 (“'398”). '398 includes two sealing lips for contact with the compressor shaft. A front sealing lip is designed for sealing against the shaft during operation while a second, rear sealing lip of larger diameter is designed to seal against the shaft when it is not in use, thus maintaining a seal both during and between uses. Further, '398 discloses an intermediate structure which provides additional angular support to the front sealing lip allowing it to better resist deformation caused by increasing coolant pressures. This design was developed in part to address abrasion of the sealing lips of prior inventions which made sealing during periods of non-use unreliable. Said abrasion resulted from friction caused by contact between the outer surface of the shaft and the front sealing lip which increased as a result of increasing coolant fluid pressures.

Similar seal mechanisms have been developed, such as that disclosed in U.S. Pat. No. 5,052,696 (“'696”), to address the need for more compact compressor seals given the ever-shrinking annular spaces surrounding the rotating shaft. '696's sealing mechanism comprises generally an elastomeric seal member bonded to a metal seal casing and a polytetrafluoroethylene seal member clamped to the casing against the elastomeric seal member. '696's compact sealing mechanism and others of its kind were developed as a direct result of the reduction in “size and weight of virtually every component used in an automobile in order to increase fuel economy.”

Other seal mechanisms of notably different design are known in the art, such as that disclosed in U.S. Pat. No. 6,322,081 (“'081”). These mechanisms utilize a stationary stator mounted to the interior of the housing with a carbon ring mounted to the stator, and a rotor having a ceramic ring mounted on the shaft. The carbon and ceramic rings contact each other on radially-inward and outward facing surfaces, respectively, whereby these rings maintain a seal between high and low-pressure compartments. '081 was developed in part to address concerns inherent in mechanisms of this type relating to thermal expansion of their constituent parts. Namely, seal failure and abrasion can result from utilizing rotors which expand in response to temperature changes at a different rate than their corresponding stators.

A recurring problem with the sealing mechanisms listed above, and indeed with all such mechanisms, is frictional wear-and-tear (abrasion) to the surfaces of the mechanisms which slide across each other during compressor operation. Regarding those sealing mechanisms which employ rubber sealing lips (e.g. '398 and '696), this abrasion occurs most frequently in the area of the sealing lips which abut the rotating shaft. Mechanisms such as that disclosed in '081 experience the abrasion on their radially-inward and outward facing surfaces, in the case of '081 those surfaces include the carbon and ceramic rings.

Attempts to combat this abrasion as well as to decrease leakage across dynamic sealing surfaces have included the application of lubricating films or coatings of oil. The oil operates to reduce friction and resulting heat which is damaging to the dynamic sealing surfaces. Unfortunately, these oils have a tendency to dry out or otherwise dissipate during periods of non-use. Following such dissipation, reinstated use of the compressor may suffer from leakage and damage to dynamic sealing surfaces.

There is thus a need for a sealing apparatus which experiences reduced abrasion of its dynamic sealing surfaces while providing an acceptable seal preventing significant leakage of coolant fluids.

### BRIEF SUMMARY OF THE INVENTION

In one embodiment of the invention the apparatus is utilized in a compressor having a compressor housing and a rotatable shaft extending through the compressor housing, and comprises a pressure seal having a first sealing member and a first sealing lip abutting and adjacent to, respectively, said housing and rotatable shaft, and a seal guide attached to the compressor housing and extending radially inward toward the rotatable shaft.

Another embodiment of the invention comprises a sealing device comprising a compressor housing having a front head, a rotatable shaft extending through the compressor housing, a pressure seal having a first sealing member and a first sealing lip abutting and adjacent to, respectively, said housing and rotatable shaft, and a seal guide attached to the front head and extending radially inward toward the rotatable shaft.

In still yet another form of the invention the device includes a compressor housing having a front head, a rotatable shaft extending through the compressor housing, a pressure seal having a first sealing member and a first sealing lip abutting and adjacent to, respectively, said housing and rotatable shaft, a second sealing lip adjacent to the rotatable shaft, and a seal guide attached to the front head and extending radially inward toward the rotatable shaft.

In still yet another form of the invention the device includes a compressor housing having a front head, a rotatable shaft extending through the compressor housing, a pressure seal having a first sealing member and a first sealing lip abutting and adjacent to, respectively, said housing and rotatable shaft, a second sealing lip adjacent to the rotatable shaft, and a seal guide comprised of oil impregnated bronze bushing attached to the front head and extending radially inward toward the rotatable shaft.

The foregoing are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. A more complete appreciation of the invention and many of the advantages thereof will be readily obtained as the same becomes better understood by references to the detailed description when considered in connection with the accompanying drawings, wherein:

FIG. 1 is a cross-sectional side view of an embodiment of the invention having a pressure seal with two sealing lips adjacent to the rotatable shaft and a seal guide attached to the interior surface of the compressor housing.

FIG. 2 is a cross-sectional side view of an embodiment of the invention having an A6 style compressor housing and seal guide attached to the front head of the compressor housing.

FIG. 3 is a cross-sectional side view of an embodiment of the invention having a pressure seal with two sealing lips adjacent to the rotatable shaft and a seal guide comprised of bronze bushing attached to the front head of the compressor housing.

### DETAILED DESCRIPTION OF THE INVENTION

As required, one or more detailed embodiments of the present invention are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

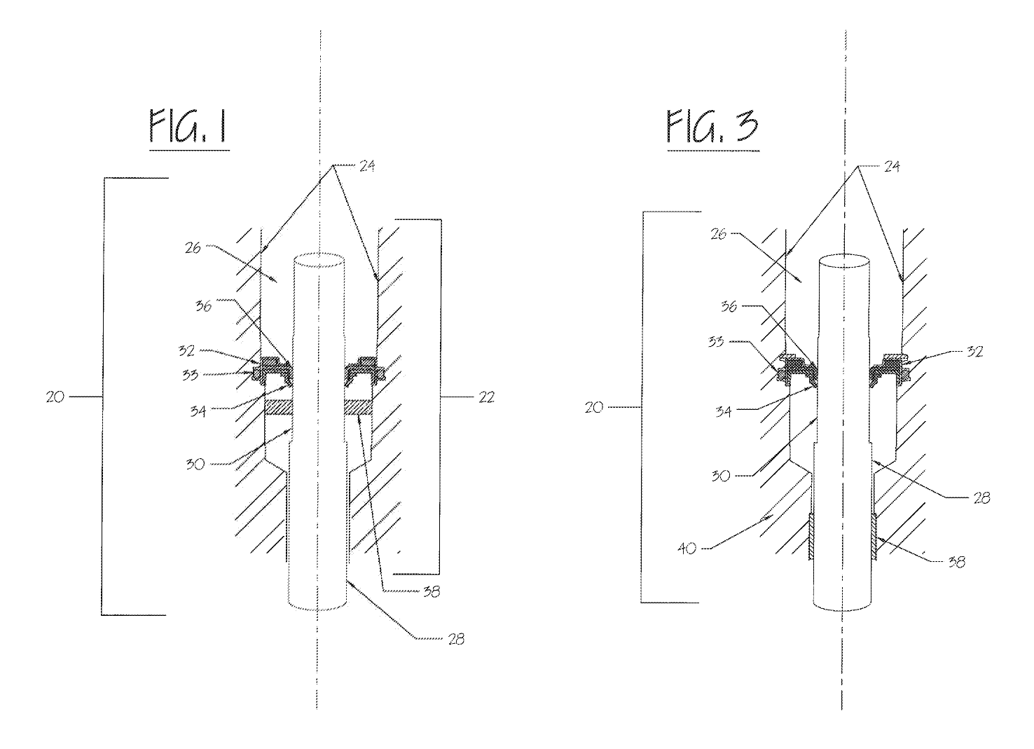

Referring now to FIGS. 1-3, wherein like reference numerals designate identical or corresponding parts through the several views, an embodiment of the present invention is displayed therein.

FIG. 1 is a cross-sectional side view of an embodiment of the invention. A sealing device 20 is comprised of a compressor housing 22 having an interior surface 24 which defines a housing cavity 26. A rotatable shaft 28 extends through the housing cavity 26 and, in the embodiment of FIG. 1, forms a substantially cylindrical shape with an outer surface 30. A pressure seal 32 occupies part of the housing cavity and seals against the interior surface 24 using a first sealing member 33 and against the outer surface 30 using first and second sealing lips 34, 36.

The first and second sealing lips 34, 36 shown in FIG. 1 are comprised of elastomeric materials, rubbers, or similar materials which are known in the art for use in sealing mechanisms. The first and second sealing lips 34, 36 seal against the outer surface 30 by, for example, being dimensioned with smaller diameter than the outer surface 30 of the rotatable shaft 28. In this embodiment, the first sealing member 33, which may be comprised of elastomeric materials, inlaid ring apparatuses or other known structures for creating a seal against the interior surface 24, abuts the interior surface 24 of the compressor housing 22 and is associated therewith or fixed thereto to provide a seal against movement of fluids from high to low pressure compartments. Other configurations and mechanisms are known in the art to achieve a seal between high and low pressure compartments of certain compressor types by utilizing at least one sealing lip, and these known sealing mechanisms may be employed in this invention without departing from its spirit and intended scope.

Also shown in FIG. 1 is a seal guide 38 which is attached to the interior surface 24 of the compressor housing 22. The seal guide 38 extends radially inward from the interior surface 24 and is adjacent to the outer surface 30 of the rotatable shaft 28. The seal guide 38 contacts the outer surface 30 at least intermittently during operation of the compressor. In so doing, the seal guide 38 helps to reduce normal deflection of the rotatable shaft 28.

Prior inventions merely accepted deflection of the rotatable shaft 28 as a “normal” consequence of operation of the compressor, and prior inventors have failed to adequately address deflection in the context of automobile air compressors. With the addition of this seal guide 38, the present invention helps reduce this deflection in a manner which reduces abrasion of at least one sealing lip. Not only does the seal guide 38 increase the lifetime of a sealing mechanism in comparison with similar prior art seals which do not include seal guides, it widens the range of potential pressure seal 32 designs which may be used as part of the sealing mechanism.

For example, A6 compressor models have frequently relied on the type of pressure seal which comprises a stationary stator mounted to the interior of the housing with a carbon ring mounted to the stator, and a rotor having a ceramic ring mounted on the shaft. One drawback to use of these types of pressure seals is that they commonly rely on oil to reduce abrasion of dynamic sealing surfaces. Unfortunately, these oils have a tendency to dry out or otherwise dissipate during periods of non-use. Following such dissipation, reinstated use of the compressor may suffer from leakage and damage to dynamic sealing surfaces. Through use of embodiments of the present invention, pressure seals 34 may be employed which are comprised of at least one sealing lip and which have reduced reliance on oils which may evaporate.

During compressor operation, the compressor's rotatable shaft 28 rotates and its outer surface 30 is in contact with at least one of the sealing lips 34, 36 of the pressure seal 32. Through the seal formed with the outer surface 30 and the seal formed by the first sealing member 33 with the interior surface 24 of the compressor housing 22, fluid movement from the high pressure side of the seal to the low is reduced or eliminated. The seal guide 38 is in at least intermittent contact with portions of the outer surface 30 to help maintain alignment and prevent deflection. This, in turn, helps to reduce abrasion, including uneven wear and tear, of at least one of sealing lips 34, 36.

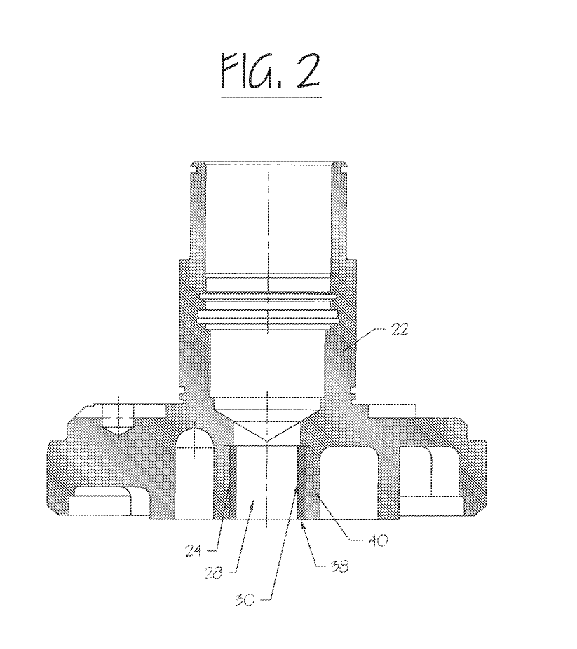

Referring now to FIG. 2, it is a cross-sectional side view of an embodiment of the invention having an altered A6 style compressor housing 22. The depicted compressor housing 22 is further comprised of a front head 40. The front head 40 is altered from its factory dimensions and is bored out to provide a larger diameter interior surface 24. The seal guide 38 is attached to the interior surface 24 of the front head 40. This embodiment of the invention provides the benefit of conserving annular space between the outer surface 30 of the rotatable shaft 28 and the interior surface 24 of the compressor housing 22 through attachment of the seal guide 38 to a bored-out section of the compressor housing 22 rather than to other portions of the compressor housing 22 as in other embodiments of the invention. Further, it is foreseen that, in a preferred embodiment, the seal guide 38 may be comprised of oil impregnated bronze bushing attached to the front head 40 of the compressor housing 22 as shown in FIG. 2.

The rotatable shaft 28 of embodiments of the invention may be polished or burnished in order to reduce outer surface 30 irregularities which may contribute to increased abrasion of the sealing lips. The rotatable shaft 28 may be polished using, for example, a 180 degree sanding belt wrap and 400 grit sandpaper at 820 RPM's to minimize shaft seal surface peaks and valleys.

Referring now to FIG. 3, it is a cross-sectional side view of an embodiment of the invention having a pressure seal with two sealing lips 34, 36 adjacent to the rotatable shaft 28 and a seal guide 38 attached to the front head 40 of the compressor housing 22.

These and other uses of, and modifications to, the present invention will be apparent to those of skill in the art upon reading this disclosure.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall there between.

What is claimed is:

1. A sealing device comprising:
a compressor housing having an interior surface defining a housing cavity;
a rotatable shaft extending through the housing cavity and having an outer surface;
a pressure seal associated with the interior surface and extending radially inward toward and abutting the outer surface of the rotatable shaft for reducing fluid communication along the housing cavity; and,
a seal guide associated with the interior surface and extending radially inward toward and at least intermittently contacting the outer surface of the rotatable shaft for reducing deflection of the rotatable shaft during compressor operation.

2. The sealing device of claim 1, wherein the compressor housing further comprises a front head and the seal guide is attached to the interior surface of the front head.

3. The sealing device of claim 1, wherein the pressure seal further comprises a first sealing member abutting the interior surface, and first and second sealing lips adjacent to the rotatable shaft.

4. The sealing device of claim 1, wherein the compressor housing is that of an A6 compressor.

5. The sealing device of claim 1, wherein the rotatable shaft is substantially cylindrical and is polished to remove surface irregularities.

6. The sealing device of claim 1, wherein the seal guide is comprised of oil impregnated bronze bushing.

7. An compressor seal comprising:
a compressor housing having an interior surface defining a housing cavity;
a rotatable shaft extending through the housing cavity and having an outer surface;
a pressure seal comprising a first sealing member abutting the interior surface and a first sealing lip adjacent to the outer surface of the rotatable shaft; and,
a seal guide attached to the interior surface of the compressor housing and extending radially inward toward the outer surface of the rotatable shaft and at least intermittently contacting the outer surface during operation to reduce the degree of rotatable shaft deflection.

8. The compressor seal of claim 7, wherein the compressor housing further comprises a front head and the seal guide is attached to the interior surface of the front head.

9. The compressor seal of claim 7, wherein the pressure seal further comprises a second sealing lip adjacent to the outer surface of the rotatable shaft.

10. The compressor seal of claim 7, wherein the rotatable shaft is substantially cylindrical and is polished to remove surface irregularities on the outer surface.

11. The compressor seal of claim 7, wherein the seal guide is comprised of oil impregnated bronze bushing.

12. The compressor seal of claim 7, wherein the compressor housing is that of an A6 compressor.

13. An apparatus for sealing in a compressor having a compressor housing with an interior surface defining a housing cavity and a rotatable shaft having an outer surface extending through the housing cavity, the apparatus comprising:
a pressure seal comprising a first sealing member abutting the interior surface and a first sealing lip adjacent to the outer surface of the rotatable shaft; and,
a seal guide attached to the interior surface of the compressor housing and extending radially inward toward the outer surface of the rotatable shaft and at least intermittently contacting the outer surface during operation to reduce the degree of rotatable shaft deflection.

14. The apparatus of claim 13, wherein the compressor housing further comprises a front head and the seal guide is attached to the interior surface of the front head.

15. The apparatus of claim 13, wherein the pressure seal further comprises a second sealing lip adjacent to the outer surface of the rotatable shaft.

16. The apparatus of claim 13, wherein the compressor housing is that of an A6 compressor.

17. The apparatus of claim 13, wherein the rotatable shaft is substantially cylindrical and is polished to remove surface irregularities on the outer surface.

18. The apparatus of claim 13, wherein the seal guide is comprised of oil impregnated bronze bushing.
